(19) United States
(12) Patent Application Publication
(10) Pub. No.: US 2009/0148720 A1
(43) Pub. Date: Jun. 11, 2009

(54) ELECTRONIC COMPONENT DEVICE, METHOD FOR MANUFACTURING ELECTRONIC COMPONENT DEVICE, ELECTRONIC COMPONENT ASSEMBLY, AND METHOD FOR MANUFACTURING ELECTRONIC COMPONENT ASSEMBLY

(75) Inventors: Hiroki KITAYAMA, Yasu-shi (JP); Yoshitsugu HORI, Toyama-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/390,566

(22) Filed: Feb. 23, 2009

Related U.S. Application Data
(63) Continuation of application No. PCT/JP2007/054408, filed on Mar. 7, 2007.

(30) Foreign Application Priority Data
Sep. 1, 2006 (JP) 2006-237128

(51) Int. Cl. B32B 3/10; B23K 31/02

(52) U.S. Cl. 428/601; 228/256

(57) ABSTRACT

An electronic component device includes an electronic component element including a lower surface having a metal surface provided thereon, a metal plate arranged so that a first principal surface thereof faces the lower surface of the electronic component element, and a first solder provided between the lower surface of the electronic component element and the first principal surface of the metal plate, the first solder arranged to connect the electronic component element to the metal plate. At least a portion of a peripheral portion of the first principal surface of the metal plate is located outwardly beyond an outer periphery of the lower surface of the electronic component element. A ridge defined by the first solder is provided in the peripheral portion of the first principal surface of the metal plate along the outer periphery of the lower surface of the electronic component element.

### BACKGROUND OF THE INVENTION

1. Field of the Invention

The present invention relates to an electronic component device including a metal plate that is bonded to an electronic component element, a method for manufacturing the electronic component device, an electronic component assembly in which the electronic component device is mounted on a substrate, and a method for manufacturing the electronic component assembly.

2. Description of the Related Art

One of the techniques related to the present invention is described in Japanese Unexamined Patent Application Publication No. 2003-258192. Japanese Unexamined Patent Application Publication No. 2003-258192 describes a method for manufacturing an electronic component module 1 shown in FIG. 4(2) through steps shown in FIG. 4(1).

As shown in FIG. 4(2), the electronic component module 1 includes an electronic component device 4 including a metal plate 3 defining a radiator plate that is bonded to an electronic component element 2. In addition, the electronic component module 1 includes a housing 5. The electronic component device 4 is disposed in the housing 5.

More specifically, the housing 5 has a multilayer structure including a plurality of stacked ceramic layers or organic material layers. In addition, the housing 5 includes a cavity 6 provided therein. The cavity 6 has an opening that is directed downward. Several external conductor films 7 are provided on the lower surface of the housing 5. The external conductor films 7 function as terminal electrodes when the electronic component module 1 is mounted on a substrate 8 defining a motherboard (refer to FIG. 5). The housing 5 includes external conductor films 9 provided on the bottom surface of the cavity 6.

The housing 5 further includes an internal conductor film and a via hole conductor provided therein (neither is shown). Several external conductor films are provided on the upper surface of the housing 5. Several surface-mounted components are mounted on the upper surface of the housing 5 so as to be electrically connected to the external conductor films.

The electronic component element 2 is made of, for example, a semiconductor chip. The electronic component element 2 includes several external conductor films 10 on an upper surface thereof, each corresponding to one of the external conductor films 9. A conductor bump 11 is provided on each of the external conductor films 10. The electronic component element 2 is flip-chip mounted to the housing 5 via the conductor bumps 11.

The electronic component element 2 includes a metal surface (not shown) on the lower surface thereof. A metal plate 3 is connected to the lower surface via a solder 12. Japanese Unexamined Patent Application Publication No. 2003-258192 describes the following method for connecting the metal plate 3 to the electronic component element 2.

As shown in FIG. 4(1), in order to connect the metal plate 3 to the electronic component element 2, the solder 12 is provided between the electronic component element 2 and the metal plate 3. The planar size of the solder 12 is determined so as to be smaller than each of the planar sizes of the electronic component element 2 and the metal plate 3. The thickness of the solder 12 is relatively large. A high melting point solder is used for the solder 12.

Subsequently, the solder 12 is melted. At the same time, as shown in FIG. 4(2), a load 13 is applied in a direction in which the metal plate 3 moves towards the electronic component element 2. In this manner, the solder 12 is spread so as to form a thin layer between the electronic component element 2 and the metal plate 3 until the lower surface of the metal plate 3 is at a height of the external conductor films 7.

However, the above-described electronic component module 1 (more precisely, the electronic component device 4) has the following problems.

FIG. 5 is an enlarged view of the electronic component module 1 mounted on the substrate 8. The substrate 8 includes a conductor film 14 provided thereon. The conductor film 14 is bonded to the metal plate 3 using a solder 15. The solder 15 is formed by applying a solder paste on the conductor film 14, placing the electronic component module 1 on the substrate 8 at a predetermined location and, subsequently, melting the solder paste.

As shown in FIG. 5, when the above-described solder 15 is melted, the solder 15 may flow to a joint portion between the electronic component element 2 and the metal plate 3. As a result, the solder 12 that connects the electronic component element 2 to the metal plate 3 is melted by the melted solder 15. Therefore, the reliability of the joint between the electronic component element 2 and the metal plate 3 may be decreased.

The electronic component module 1 shown in FIG. 5 includes a space between the electronic component element 2 and the bottom surface of the cavity 6 that is not filled with an underfill resin. In such a case, if, as shown by a dotted line in FIG. 5, the melted solder 15 flows over the upper surface of the electronic component element 2, a short circuit may occur between the conductor bumps 11. To prevent this, an underfill resin is required.

In addition, the joint between the electronic component element 2 and the metal plate 3 is maintained only by the joining force provided by the solder 12. Accordingly, the joint is relatively easily disengaged by a shearing force.

### SUMMARY OF THE INVENTION

To overcome the problems described above, preferred embodiments of the present invention provide an electronic component device having a structure in which a metal plate is bonded to an electronic component element, a method for manufacturing the electronic component device, an electronic component assembly having a structure in which the electronic component device is mounted on a substrate, and a method for manufacturing the electronic component assembly.

According to a preferred embodiment of the present invention, an electronic component device includes an electronic component element having a lower surface on which a metal surface is provided, a metal plate arranged so that a first principal surface thereof faces the lower surface of the electronic component element, and a first solder provided between the lower surface of the electronic component element and the first principal surface of the metal plate, where the first solder connects the electronic component element to the metal plate.

At least a portion of a peripheral portion of the first principal surface of the metal plate is located outwardly beyond an outer periphery of the lower surface of the electronic component element, and a ridge is defined by the first solder in the peripheral portion of the first principal surface of the metal plate along the outer periphery of the lower surface of the electronic component element.

Preferably, the entire or substantially the entire peripheral portion of the first principal surface of the metal plate is located outwardly beyond an outer periphery of the lower surface of the electronic component element, and the ridge is preferably provided in the peripheral portion of the first principal surface of the metal plate along the entire or substantially the entire outer periphery of the first principal surface.

Preferably, the metal plate defines a radiator plate.

In addition, according to a preferred embodiment of the present invention, an electronic component assembly is provided. The electronic component assembly includes the above-described electronic component device and a substrate having the electronic component device mounted thereon. The substrate includes a metal surface arranged so that the metal surface faces a second principal surface, opposite to the first principal surface, of the metal plate provided to the electronic component device, and the electronic component device is connected to the substrate with a second solder provided between the second principal surface of the metal plate and the metal surface of the substrate. A melting point of the second solder is lower than that of the first solder.

Furthermore, according to a preferred embodiment of the present invention, a method for manufacturing an electronic component device is provided.

The method for manufacturing an electronic component device includes the steps of preparing an electronic component element having a metal surface provided on a lower surface thereof, preparing a metal plate having dimensions such that, when the metal plate is arranged so that a first principal surface thereof faces the lower surface of the electronic component element, at least a portion of a peripheral portion of the first principal surface of the metal plate is located outwardly beyond an outer periphery of the lower surface of the electronic component, and preparing a first solder.

The method preferably further includes the step of arranging the electronic component element and the metal plate so that the first principal surface of the metal plate faces the lower surface of the electronic component element with the first solder therebetween.

The method preferably further includes the step of connecting the electronic component element to the metal plate by melting the first solder and applying a load in a direction in which the metal plate moves towards the electronic component element. In this manner, a portion of the first solder extends outwardly beyond an outer periphery of the lower surface of the electronic component element, and a ridge is defined by the first solder in the peripheral portion of the first principal surface of the metal plate along the outer periphery of the lower surface of the electronic component element.

According to a preferred embodiment of the present invention, a method for manufacturing an electronic component assembly is provided.

The method for manufacturing an electronic component assembly includes the steps of preparing the above-described electronic component device, preparing a substrate having a metal surface on at least one of two sides, where the substrate is used to mount the electronic component device thereon, and preparing a second solder having a melting point lower than that of the first solder.

Preferably, the method for manufacturing an electronic component assembly further includes the step of connecting the electronic component device to the substrate by arranging the electronic component device and the substrate such that the metal surface of the substrate faces a second principal surface, opposite to the first principal surface, of the metal plate provided to the electronic component device with a second solder therebetween and melting the second solder using a temperature lower than a melting point of the first solder.

According to the electronic component device of a preferred embodiment of the present invention, the ridge is defined by the first solder in the peripheral portion of the first principal surface of the metal plate along the outer periphery of the lower surface of the electronic component element. Accordingly, when the electronic component device is mounted on the substrate in order to produce the electronic component assembly, when the second solder provided between the second principal surface of the metal plate and the metal surface of the substrate is melted and even if the melted second solder rises along the end surface of the metal plate, flow of the melted second solder is stopped by the ridge. Consequently, the melted second solder cannot enter the joint portion between the electronic component element and the metal plate. As a result, melting of the first solder that connects the electronic component element to the metal plate is prevented. As a result, a highly reliable joint between the electronic component element and the metal plate is ensured.

In addition, according to a preferred embodiment of the present invention, when the electronic component device is disposed in the housing, the second solder arranged to connect the electronic component device to the substrate does not flow into a portion between the upper surface of the electronic component element and the housing. Accordingly, a space between the electronic component element and the housing need not be filled with an underfill resin. Furthermore, a circuit can be provided on the upper surface of the electronic component element without a protective film.

Furthermore, since the ridge is arranged on the metal plate along the outer periphery of the lower surface of the electronic component element, a mechanical locking force is exerted between the electronic component element and the metal plate in addition to a bonding force generated by the first solder. Accordingly, a high bonging strength and, in particular, a high shear strength is obtained between the electronic component element and the metal plate. Therefore, the reliability of the joint can be further increased.

When the entire or substantially the entire peripheral portion of the first principal surface of the metal plate is located outwardly beyond an outer periphery of the lower surface of the electronic component element and the ridge is provided in the peripheral portion of the first principal surface of the metal plate along the entire or substantially the entire outer periphery of the first principal surface, the above-described advantages can be more reliably and more effectively provided.

In the method for manufacturing an electronic component device according to a preferred embodiment of the present invention, the electronic component element is connected to the metal plate by melting the first solder and applying a load in a direction in which the metal plate moves towards the electronic component element. Thus, a portion of the first solder extends outwardly beyond an outer periphery of the lower surface of the electronic component element, and a ridge is defined by the first solder in the peripheral portion of the first principal surface of the metal plate along the outer periphery of the lower surface of the electronic component element. Accordingly, when an electronic component device is manufactured, special processing of the metal plate is not required. In addition, existing manufacturing equipment can be used without providing any special steps. As a result, the advantages of preferred embodiments of the present invention can be provided without decreasing the productivity and without increasing the manufacturing cost.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view of an electronic component module including an electronic component device according to a preferred embodiment of the present invention.

FIGS. 2(1) and 2(2) are cross-sectional views illustrating a method for manufacturing the electronic component device shown in FIG. 1.

FIG. 3 is an enlarged cross-sectional view of a main portion of an electronic component assembly including the electronic component device shown in FIG. 1 and a substrate having the electronic component device mounted thereon.

FIGS. 4(1) and 4(2) are cross-sectional views illustrating an existing electronic component device, which is a related art of the present invention, and a method for manufacturing the electronic component device.

FIG. 5 is an enlarged cross-sectional view of the electronic component device shown in FIG. 4(2) mounted on a substrate.

### DETAILED DESCRIPTION OF PREFERRED EMBODIMENTS

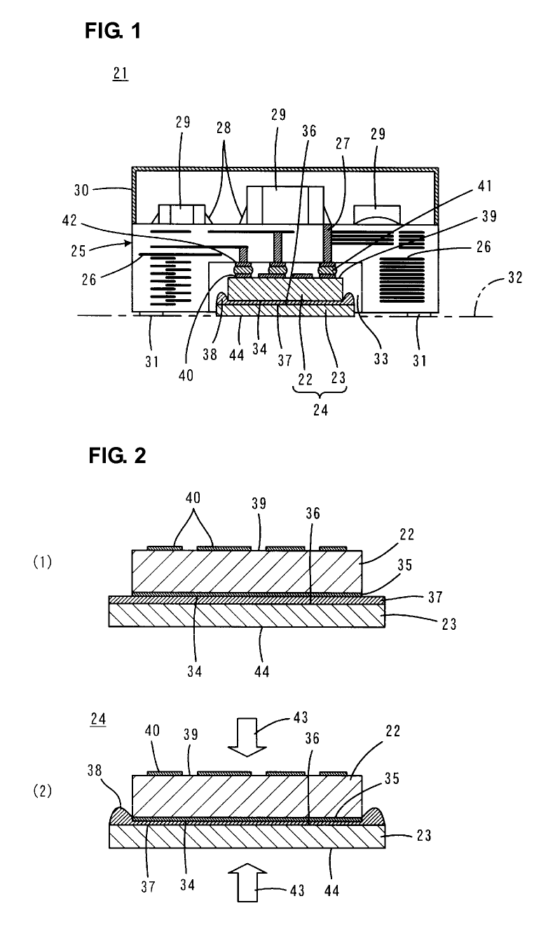

FIG. 1 is a cross-sectional view of an electronic component module 21 according to a preferred embodiment of the present invention.

The electronic component module 21 includes an electronic component device 24 including a metal plate 23 that is bonded to an electronic component element 22. In addition, the electronic component module 21 includes a housing 25. The electronic component device 24 is disposed in the housing 25.

The housing 25 has a multilayer structure including a plurality of ceramic layers or organic material layers stacked therein. The housing 25 includes several internal conductor films 26 and several via hole conductors 27 provided therein. The internal conductor films 26 and via hole conductors 27 are included in an interconnection conductor. The interconnection conductor preferably defines a passive component, such as an inductor, a capacitor, or a resistor, for example.

Several external conductor films (not shown) are provided on the upper surface of the housing 25 as required. Several surface-mounted components 29 are mounted on the upper surface of the housing 25 so as to be connected to the external conductor films via solder portions 28. In addition, a metal cover 30 is mounted on the upper surface of the housing 25 so as to cover the surface-mounted components 29.

The housing 25 includes several external conductor films 31 provided on the lower surface thereof. The external conductor films 31 define terminal electrodes when the electronic component module 21 is mounted on a substrate 32 defining a motherboard indicated by an imaginary line.

The housing 25 further includes a cavity 33 on the lower side thereof. The cavity 33 has an opening that is directed downwards. The above-described electronic component device 24 is disposed in the cavity 33.

Examples of the electronic component element 22 of the electronic component device 24 include a semiconductor element (e.g., an IC chip), an inductor element, a capacitor element, a resistor element, and a piezoelectric element. The metal plate 23 preferably defines a radiator plate. Preferably, the metal plate 23 is made of metal having a relatively high heat conductivity, such as a Ni—Co—Fe alloy, a Ni—Fe alloy, a Ni—Cr—Fe alloy, a Cr—Fe alloy, a Cr—Ni alloy, Cu, or Al, for example. Note that the metal plate 23 has a simple planar shape.

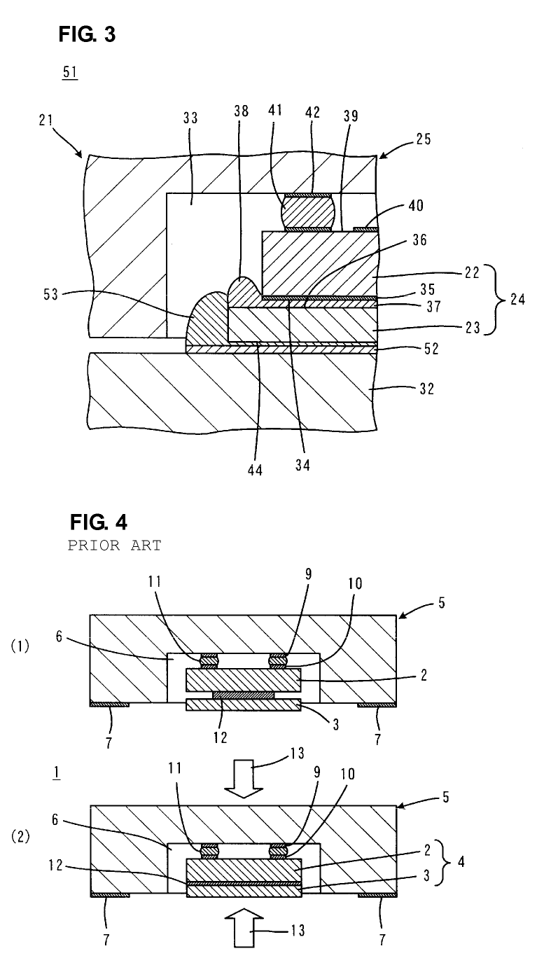

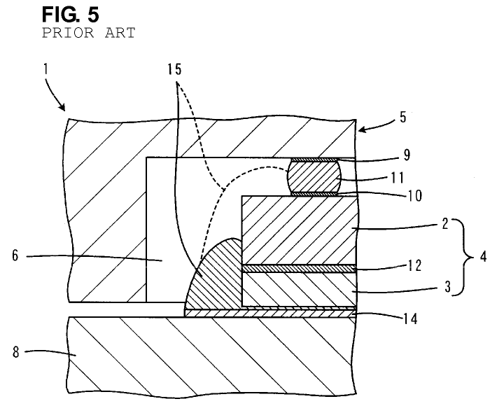

The electronic component element 22 has a lower surface 34 having a metal surface provided thereon. More specifically, a metal film 35 (refer to FIGS. 2 and 3) is provided on the lower surface 34 of the electronic component element 22. The metal plate 23 is arranged so that a first principal surface 36 of the metal plate 23 faces the lower surface 34 of the electronic component element 22. At that time, in order to connect the electronic component element 22 to the metal plate 23, a first solder 37 is provided between the lower surface 34 of the electronic component element 22 and the first principal surface 36 of the metal plate 23. For example, an AuSn solder having a relatively high melting point is preferably used for the first solder 37.

A peripheral portion of the first principal surface 36 of the metal plate 23 is located outwardly beyond the outer periphery of the lower surface 34 of the electronic component element 22. A ridge 38 is provided by the first solder 37 along the outer periphery of the lower surface 34 of the electronic component element 22 in the peripheral portion of the first principal surface 36 of the metal plate 23 located beyond the outer periphery of the lower surface 34 of the electronic component element 22. Preferably, the peripheral portion of the first principal surface 36 of the metal plate 23 is located beyond the entire or substantially the entire outer periphery of the lower surface 34 of the electronic component element 22, and the ridge 38 is arranged so as to extend along the entire or substantially the entire periphery of the peripheral portion of the first principal surface 36 of the metal plate 23.

Several external conductor films 40 are provided on the upper surface 39 of the electronic component element 22. Conductor bumps 41 are provided on predetermined ones of the external conductor films 40. In addition, external conductor films 42 are provided on the bottom surface of the cavity 33. The electronic component element 22 included in the cavity 33 is fusion bonded to the external conductor films 42 via the conductor bumps 41.

A method for manufacturing the electronic component module 21 (more particularly, the electronic component device 24) is described below with reference to FIGS. 2(1) and 2(2).

The electronic component element 22 is prepared first. Although not shown in FIG. 2, the electronic component element 22 is disposed in the cavity 33 of the housing 25, as shown in FIG. 1.

In addition, the metal plate 23 and the first solder 37 are prepared. Subsequently, as shown in FIG. 2(1), the electronic component element 22 and the metal plate 23 are arranged so that the first principal surface 36 of the metal plate 23 faces the lower surface 34 of the electronic component element 22 with the first solder 37 therebetween. Note that, according to the present preferred embodiment, the first solder 37 is preferably in the form of a sheet with a size the same or substantially the same as that of the metal plate 23. The first solder 37 may be formed in advance on the first principal surface 36 of the metal plate 23 so as to extend over the first principal surface 36 and form a layer.

Subsequently, the first solder 37 is melted in a reflow furnace. Thereafter, as shown in FIG. 2(2), a load 43 is applied using, for example, a spindle in a direction in which the metal plate 23 moves towards the electronic component element 22. In this manner, the electronic component element 22 is connected to the metal plate 23. At the same time, a portion of the first solder 37 extends outwardly beyond the outer periphery of the lower surface 34 of the electronic component element 22. As a result, in the peripheral portion of the first principal surface 36 of the metal plate 23, the ridge 38 is defined by the first solder 37 along the outer periphery of the lower surface 34 of the electronic component element 22. Note that the electronic component element 22 is moved towards the metal plate 23 by the load 43 until a second principal surface 44 of the metal plate 23 opposite to the first principal surface 36 is arranged at a height of the external conductor films 31.

As described above, in order to easily perform adjustment so that the height of the second principal surface 44 of the metal plate 23 is the same or substantially the same as the height of the external conductor films 31, the electronic component element 22 may be mounted in the housing 25, and, subsequently, the metal plate 23 may be connected to the electronic component element 22. However, if the easy adjustment is not required, the electronic component element 22 may be connected to the metal plate 23 in advance so as to form the electronic component device 24 and, subsequently, the electronic component element 22 may be mounted in the housing 25.

FIG. 3 is an enlarged view of a main portion of an electronic component assembly 51 including the above-described electronic component device 24 and the substrate 32 having the electronic component device 24 mounted thereon.

The substrate 32 includes a conductor film 52 provided thereon. The conductor film 52 defines a metal surface which is arranged so as to face the second principal surface 44 of the metal plate 23 in the electronic component device 24. The electronic component device 24 is connected to the substrate 32 using a second solder 53 provided between the second principal surface 44 of the metal plate 23 and the conductor film 52 of the substrate 32. For example, a SnAg solder is preferably used for the second solder 53. The melting point of the second solder 53 is preferably lower than that of the first solder 37.

In order to produce the electronic component assembly 51 shown in FIG. 3, the electronic component device 24 and the substrate 32 are arranged so that the second principal surface 44 of the metal plate 23 in the electronic component device 24 faces the conductor film 52 of the substrate 32 with the second solder 53 therebetween. Subsequently, the second solder 53 is melted in, for example, a reflow furnace using a temperature lower than the melting point of the first solder 37. In this manner, the electronic component device 24 is connected to the substrate 32 so that the electronic component assembly 51 shown in FIG. 3 is provided.

As shown in FIG. 3, when the second solder 53 is melted and even if the melted second solder 53 extends along the end surface of the metal plate 23, the melted second solder 53 is advantageously stopped by the ridge 38. Accordingly, even when the melted second solder 53 melts the first solder 37, only a portion of the ridge 38 is melted, and therefore, a portion of the first solder 37 disposed between the electronic component element 22 and the metal plate 23 is not melted. As a result, a highly reliable joint between the electronic component element 22 and the metal plate 23 can be ensured.

Examples to illustrate preferred embodiments of the present invention have been described. However, various modifications may be made without departing from the spirit and scope of the present invention.

For example, in the above-described preferred embodiment, the entire or substantially the entire peripheral portion of the first principal surface 36 of the metal plate 23 is preferably located outwardly beyond the periphery of the lower surface 34 of the electronic component element 22. The ridge 38 is arranged preferably so as to extend along the entire or substantially the entire periphery of the peripheral portion of the first principal surface 36 of the metal plate 23. However, for example, a portion of the ridge extending along the outer periphery of the electronic component element may be removed when a notch is provided in the metal plate so that a portion of the peripheral portion of the metal plate is aligned with the outer periphery of the bottom surface of the electronic component element.

In addition, in the above-described preferred embodiments, the electronic component device 24 is preferably configured such that the electronic component device 24 is disposed in the housing 25 having the cavity 33. However, the electronic component device 24 does not necessarily have such a configuration. Alternatively, in place of the housing, the electronic component device may be mounted on a simple planar substrate.

An example of an experiment performed in order to demonstrate the high shear strength of the joint portion between the electronic component element and the metal plate is described below.

The following electronic component devices were produced as samples of various preferred embodiments of the present invention.

An electronic component element having a length of about 2 mm, a width of about 1 mm, and a thickness of about 0.1 mm was used. A Ti film having a thickness of about 0.05 μm defining the metal film was formed on the lower surface of the electronic component element using a thin-film forming process, such as a sputtering process, for example. In a similar manner, an Au film having a thickness of about 0.1 μm was formed over the Ti film. Furthermore, an Au film having a thickness of about 5.0 μm was formed over the Au film using electrolytic plating, for example. In addition, a metal plate having a planar size greater than that of the electronic component element 2 (about 2 mm×about 1 mm) by about 0.5 mm was used. An AuSn solder was used for the first solder. A layer of the sheet-shaped first solder having a thickness of about 0.03 mm was formed on a first principal surface of the metal plate before the metal plate was connected.

Subsequently, the electronic component element and the metal plate were arranged so that a first principal surface of the metal plate faced the bottom surface of the electronic component element with the first solder therebetween. By melting the first solder in a reflow furnace and applying a load of about 2N in a direction in which the electronic component element moved towards the metal plate, a ridge having a height of about 50 μm was formed from the first solder in the peripheral portion of the first principal surface of the metal plate.

In contrast, as a comparative example, an electronic component device was produced in a manner similar to that of the first preferred embodiment except that, in the step of melting the first solder and joining the electronic component element to the metal plate 23, no load was applied and no ridge was formed.

The measured shear strengths of 15 samples according to the present preferred embodiment and 17 samples of the comparative example are shown in TABLE 1.

TABLE 1

| | Preferred | Comparative |
|---|---|---|
| Sample No. | Embodiment | Example |
| 1 | 105.2 | 72.0 |
| 2 | 180.5 | 88.6 |
| 3 | 72.1 | 116.6 |
| 4 | 186.2 | 52.9 |
| 5 | 180.0 | 147.3 |
| 6 | 186.9 | 110.8 |
| 7 | 116.9 | 136.2 |
| 8 | 157.2 | 75.5 |
| 9 | 178.0 | 83.5 |
| 10 | 131.6 | 137.1 |
| 11 | 166.7 | 187.1 |
| 12 | 171.0 | 160.5 |
| 13 | 198.6 | 103.3 |
| 14 | 183.1 | 147.0 |
| 15 | 85.6 | 145.1 |
| 16 | — | 156.3 |
| 17 | — | 85.3 |
| Mean Value | 153.3 | 117.9 |

(Unit: “N”)

As shown in TABLE 1, according to the present preferred embodiment, a high shear strength can be obtained, as compared to that of the comparative example.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. An electronic component device comprising:
an electronic component element including a lower surface having a metal surface provided thereon;
a metal plate arranged so that a first principal surface thereof faces the lower surface of the electronic component element; and
a first solder provided between the lower surface of the electronic component element and the first principal surface of the metal plate, the first solder arranged to connect the electronic component element to the metal plate; wherein
at least a portion of a peripheral portion of the first principal surface of the metal plate is located outwardly beyond an outer periphery of the lower surface of the electronic component element; and
a ridge defined by the first solder is provided in the peripheral portion of the first principal surface of the metal plate along the outer periphery of the lower surface of the electronic component element.

2. The electronic component device according to claim 1, wherein the entire or substantially the entire peripheral portion of the first principal surface of the metal plate is located outwardly beyond an outer periphery of the lower surface of the electronic component element, and the ridge is provided in the peripheral portion of the first principal surface of the metal plate along the entire or substantially the entire outer periphery of the first principal surface.

3. The electronic component device according to claim 1, wherein the metal plate defines a radiator plate.

4. An electronic component assembly comprising:
the electronic component device according to claim 1; and
a substrate having the electronic component device mounted thereon; wherein
the substrate has a metal surface arranged so that the metal surface faces a second principal surface, opposite to the first principal surface, of the metal plate provided to the electronic component device;
the electronic component device is connected to the substrate with a second solder provided between the second principal surface of the metal plate and the metal surface of the substrate; and
a melting point of the second solder is lower than that of the first solder.

5. A method for manufacturing an electronic component device, comprising the steps of:
preparing an electronic component element having a metal surface provided on a lower surface thereof;
preparing a metal plate having dimensions such that, when the metal plate is arranged so that a first principal surface thereof faces the lower surface of the electronic component element, at least a portion of a peripheral portion of the first principal surface of the metal plate is located outwardly beyond an outer periphery of the lower surface of the electronic component;
preparing a first solder;
arranging the electronic component element and the metal plate so that the first principal surface of the metal plate faces the lower surface of the electronic component element with the first solder therebetween;
connecting the electronic component element to the metal plate by melting the first solder and applying a load in a direction in which the metal plate moves towards the electronic component element, outwardly extending a portion of the first solder beyond an outer periphery of the lower surface of the electronic component element, and forming a ridge from the first solder in the peripheral portion of the first principal surface of the metal plate along the outer periphery of the lower surface of the electronic component element.

6. A method for manufacturing an electronic component assembly, comprising the steps of:
preparing the electronic component device according to claim 1;
preparing a substrate having a metal surface on at least one of two sides thereof, the substrate being used to mount the electronic component device thereon;
preparing a second solder having a melting point lower than that of the first solder; and
connecting the electronic component device to the substrate by arranging the electronic component device and the substrate so that the metal surface of the substrate faces a second principal surface, opposite to the first principal surface, of the metal plate provided to the electronic component device with a second solder therebetween and melting the second solder using a temperature lower than a melting point of the first solder.
